(19) United States
(12) Patent Application Publication
(10) Pub. No.: US 2014/0165945 A1
(43) Pub. Date: Jun. 19, 2014

(54) LASER SPARK PLUG

(71) Applicants: Pascal Woerner, Korntal-Muenchigen (DE); Juergen Ralmann, Weil Der Stadt (DE); Joerg Engelhardt, Ditzingen (Hirschlanden) (DE); Martin Weinrotter, Vitoria-Gasteiz (ES)

(72) Inventors: Pascal Woerner, Korntal-Muenchigen (DE); Juergen Ralmann, Weil Der Stadt (DE); Joerg Engelhardt, Ditzingen (Hirschlanden) (DE); Martin Weinrotter, Vitoria-Gasteiz (ES)

(73) Assignee: ROBERT BOSCH GMBH, Stuttgart (DE)

(21) Appl. No.: 14/115,975

(22) PCT Filed: Mar. 12, 2012
(86) PCT No.: PCT/EP2012/054223

§ 371 Date: Mar. 10, 2014

(30) Foreign Application Priority Data
May 10, 2011 (DE) 10 2011 075 559.4

(51) Int. Cl. F02P 23/04

(52) U.S. Cl. CPC F02P 23/04
USPC 123/143 B

(57) ABSTRACT

A laser spark plug, e.g., for an engine, includes a prechamber that accommodates an ignitable medium, an arrangement for radiating laser radiation onto an ignition point in the prechamber, at least one crossflow channel that enables a fluid connection between an internal space of the prechamber and an external space, and a screen arranged between the radiating arrangement and the prechamber with an outlet opening for entry of the laser radiation into the prechamber. The at least one crossflow channel is arranged to provide a fluid flow therethrough and into the prechamber, such that the direction of flow forms an angle of a maximum of approximately 30° with a longitudinal axis of the prechamber, and the flow is directed into a spatial region of the prechamber that is situated essentially predominantly, preferably completely, outside a central region of the outlet opening of the screen.

### FIELD OF THE INVENTION

The present invention relates to a laser spark plug, in particular for an internal combustion engine of a motor vehicle or for a large gas engine, the spark plug including a prechamber for accommodating an ignitable medium, an arrangement for radiating laser radiation onto at least one ignition point in the prechamber, and at least one crossflow channel that provides for a fluid connection between an interior space of the prechamber and an external space surrounding the prechamber.

### BACKGROUND

A laser spark plug is known for example from EP 2 072 803 A2.

### SUMMARY

An object of the present invention is to improve a laser spark plug of the type referred to above in such a way that more reliable operation and increased useful life are ensured.

According to an example embodiment of the present invention, in furtherance of this objective, a screen is situated between a laser radiation radiating arrangement and the prechamber, the screen including at least one outlet opening into the prechamber via which the laser radiation enters the prechamber, and at least one crossflow channel is situated and fashioned in such a way that when a fluid flows through the crossflow channel into an internal space of the prechamber, a fluid flow results whose direction of flow forms an angle of a maximum of approximately 30° with a longitudinal axis of the prechamber, and that is directed into a spatial region of the prechamber that is situated predominantly, preferably completely, outside a central region of the outlet opening of the screen.

According to investigations carried out by the inventors, the configuration according to the present invention of the prechamber and the at least one crossflow channel advantageously enables the formation of a fluid flow in the prechamber that can be ignited particularly well by laser radiation, and at the same time advantageously ensures that there does not result any significant stagnation point flow from the interior space of the prechamber through the screen, for example toward a combustion chamber window, so that in this way a contamination of the relevant components, in particular of the combustion chamber window, can be prevented in a particularly efficient manner

In this way, there advantageously results an increased useful life of the laser spark plug, with simultaneously reliable operating properties.

In particular, the configuration according to the present invention is superior to conventional approaches that provide the formation of a dominant tumble flow (tangential flow in the region of the combustion chamber window) or of a dominant swirl flow, in which a main turbulence axis is situated essentially concentric to the longitudinal axis of the prechamber or of the laser spark plug.

In a particularly advantageous specific embodiment, at least two crossflow channels are provided, and the crossflow channels are situated in such a way that a longitudinal axis of the first crossflow channel forms a first angle with the longitudinal axis of the prechamber, and that a longitudinal axis of the second crossflow channel forms a second angle with the longitudinal axis of the prechamber, the second angle being different from the first angle. In this variant of the present invention, in which the crossflow channels themselves are for example preferably formed as essentially circular-cylindrical channels, a fluid flow flowing into the interior space of the prechamber is advantageously obtained that satisfies the criteria according to the present invention. In particular, the direction of flow of the fluid flow obtained according to the present invention in the prechamber can be influenced by the angular difference between the longitudinal axes of the at least two crossflow channels, so that an angle between the direction of flow and the longitudinal axis of the prechamber does not exceed a value of approximately 30°, and that, in particular, the direction of flow is directed into a spatial region that is not situated in the central region of the outlet opening of the screen. The design explained above with reference to the example of two crossflow channels can also be carried over to more than two crossflow channels.

In a further advantageous example embodiment, at least two crossflow channels are provided, and the crossflow channels are situated in such a way that a point of entry of the first crossflow channel into the prechamber, more precisely into the interior space of the prechamber, is at a first distance from an axial reference point, and that a point of entry of the second crossflow channel into the prechamber, or into the internal space of the prechamber, is at a second distance from the axial reference point, the second distance being different from the first distance. An essentially flat surface can for example be used as an axial reference point, the surface extending essentially orthogonal to the longitudinal axis of the laser spark plug and of the prechamber, for example a surface of a combustion chamber window of the laser spark plug, which surface faces the screen. Alternatively, for example an end face of the screen that delimits an end region of the internal space of the prechamber can also be used as an axial reference point. In all cases, for the definition of the distances a measurement is preferably carried out along a spatial coordinate on a the longitudinal axis of the laser spark plug and of the prechamber or on a line extending parallel thereto.

Combinations of the variants of the present invention described above can also be provided. For example, a plurality of crossflow channels can be provided whose points of entry into the prechamber each are at the same distance to an axial reference point, but whose longitudinal axes form different respective angles with the longitudinal axis of the prechamber. It is also possible for a plurality of crossflow channels to be provided whose longitudinal axes each form the same angle with the longitudinal axis of the prechamber, at least two of these crossflow channels being situated in the prechamber in such a way that they are at different distances from the axial reference point.

According to an example embodiment, channels longitudinal axes of two or more crossflow are at different angles to the longitudinal axis of the prechamber, and in addition the distances of their points of entry to the axial reference point differ.

In a further advantageous variant of the present invention, it is provided that at least one crossflow channel is provided and is fashioned as a center hole, i.e., is situated in an end region at the combustion chamber side of the prechamber, approximately in the region of the longitudinal axis of the prechamber. Particularly preferably, however, a longitudinal axis of the center hole does not coincide precisely with the longitudinal axis of the prechamber, but rather is preferably situated parallel thereto. Such an axial offset can also promote the fluid flow according to the present invention in the prechamber. Variants of the present invention can be provided in which the above-described center hole forms the only crossflow channel, but, in addition, combinations of the variant that includes the center hole with the other above-described embodiments of the present invention can also be provided, including crossflow channels with different orientations of their longitudinal axes or of their points of entry relative to an axial reference point.

In a further example embodiment of the present invention, it is provided that at least two crossflow channels are situated in such a way that their longitudinal axes each intersect the longitudinal axis of the prechamber. This configuration is also referred to as a radial orientation of the crossflow channels. If the orientations of the respective longitudinal axes of the relevant crossflow channels are different or if the points of entry of the respective crossflow channels differ, then there results individual points of intersection between the respective longitudinal axis of a crossflow channel and the longitudinal axis of the prechamber, i.e., the longitudinal axes of the crossflow channels do not intersect each other.

In a further advantageous example embodiment of the present invention, it is provided that at least two crossflow channels are situated in such a way that their longitudinal axes do not intersect the longitudinal axis of the prechamber, and therefore go past it, such that preferably an imaginary triangle two sides of which are the two longitudinal axes and the third side of which is formed by an imaginary connecting line between the respective points of entry of the crossflow channels into the prechamber, includes a point of intersection with the longitudinal axis of the prechamber. Thus, in this case it is ensured that the longitudinal axis of the prechamber is situated within the points of entry and the point of intersection of the longitudinal axes of the relevant crossflow channels, or of the triangle formed therefrom, so that the partial flows resulting from the individual crossflow channels into the prechamber at least partly mutually compensate one another in order to prevent the formation of a dominant swirl flow or of a dominant tumble flow.

In a further example embodiment, the situation of the crossflow channels can take place such that at least one angle bisector of the imaginary triangle of the above-described specific embodiment intersects the longitudinal axis or optical axis of the prechamber.

In a further advantageous example embodiment, it is provided that at least two crossflow channels are situated approximately parallel to one another and in such a way that the longitudinal axis of the prechamber is situated between the respective longitudinal axes of the crossflow channels. In this case as well, there is advantageously a compensation of the partial flows flowing through the two participating crossflow channels, such that the formation of a dominant swirl or tumble flow is avoided.

In a further advantageous example embodiment of the present invention, it can be provided that an angular spacing of crossflow channels adjacent to one another in the circumferential direction of the prechamber is not constant. For example, given a total number of five radially situated crossflow channels, an angular spacing of four cross channels from each other can be approximately 60°, while between two adjacent crossflow channels there results a remaining angular spacing of approximately 120°.

In another advantageous example embodiment, it is provided that at least one crossflow channel includes a first cross-sectional surface facing the external space, this surface differing with respect to its form and/or surface content from a second cross-sectional surface facing the internal space of the prechamber, thus providing further degrees of freedom for influencing the fluid flow in the prechamber.

In a further advantageous example embodiment, it is provided that at least one through-channel of the screen is approximately frustum-shaped, an opening angle of the through-channel being greater than or approximately equal to an angle of radiation of the laser radiation, so that the laser radiation can be radiated into the prechamber essentially unhindered through the screen from the laser spark plug or from a laser device provided there, or the like, while at the same time a shielding effect of the components of the laser spark plug (e.g., combustion chamber window) is provided against dirt particles or combustion end products (oil ashes and the like) originating from the prechamber.

Further advantages, features, and details result from the following description, in which various exemplary embodiments of the present invention are presented with reference to the drawing.

### BRIEF DESCRIPTION OF THE DRAWINGS

FIG. 1a schematically shows a partial cross-section of a first example embodiment of a laser spark plug according to the present invention.

FIG. 1b schematically shows a partial cross-section of an end region, including a prechamber and facing the combustion chamber, of the laser spark plug according to FIG. 1a.

FIG. 1c schematically shows a top view of the prechamber of the laser spark plug according to FIG. 1b, in a partial cross-section.

FIG. 1d schematically shows a top view of an end region of the screen, facing the prechamber, according to an example embodiment of the present invention.

FIG. 2 schematically shows, in partial cross-section, a prechamber according to a further example embodiment.

FIG. 3 shows a top view of an end region of a prechamber, facing the combustion chamber, according to a further example embodiment.

FIG. 4 schematically shows a partial cross-section of a prechamber according to a further example embodiment.

FIG. 5 schematically shows a partial cross-section of a prechamber according to a further example embodiment.

FIG. 6 schematically shows a partial cross-section of a prechamber according to a further example embodiment.

FIG. 7 schematically shows a partial cross-section of the screen according to an example embodiment of the present invention.

FIG. 8a schematically shows a configuration and orientation of crossflow channels relative to a longitudinal axis of the prechamber according to a further example embodiment.

FIG. 8b schematically shows a further configuration of crossflow channels relative to a longitudinal axis of a prechamber according to a further example embodiment.

### DETAILED DESCRIPTION

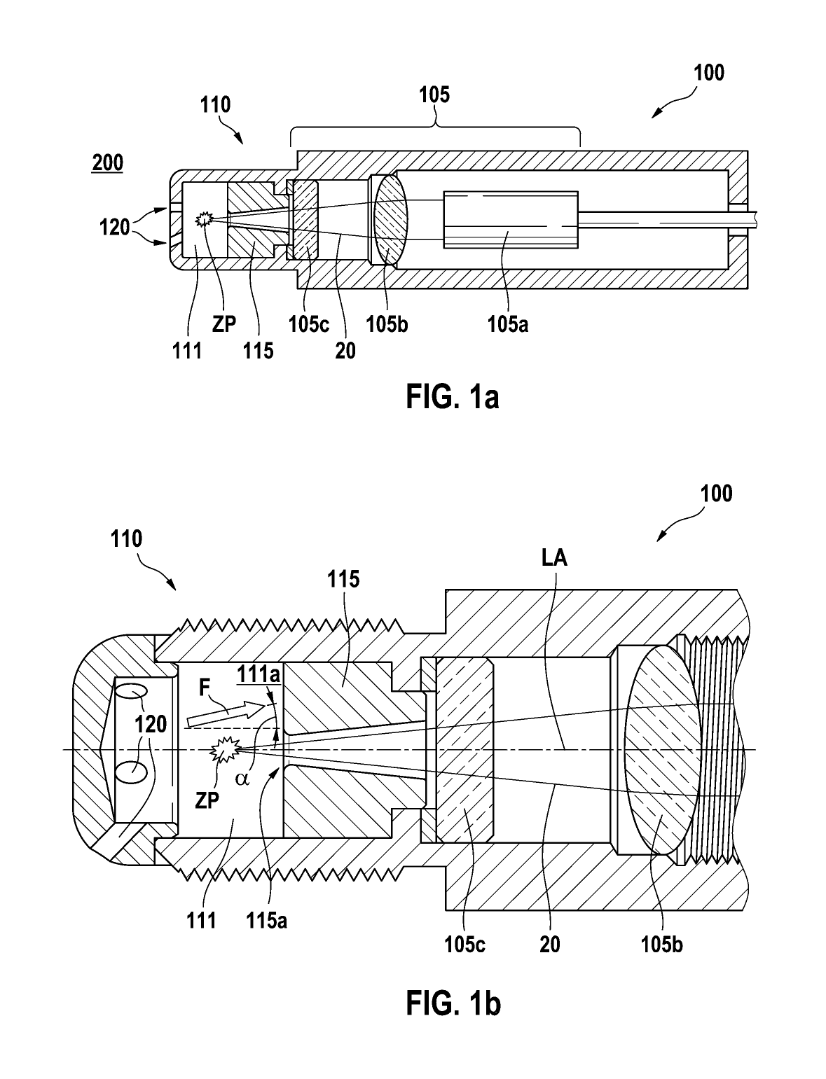

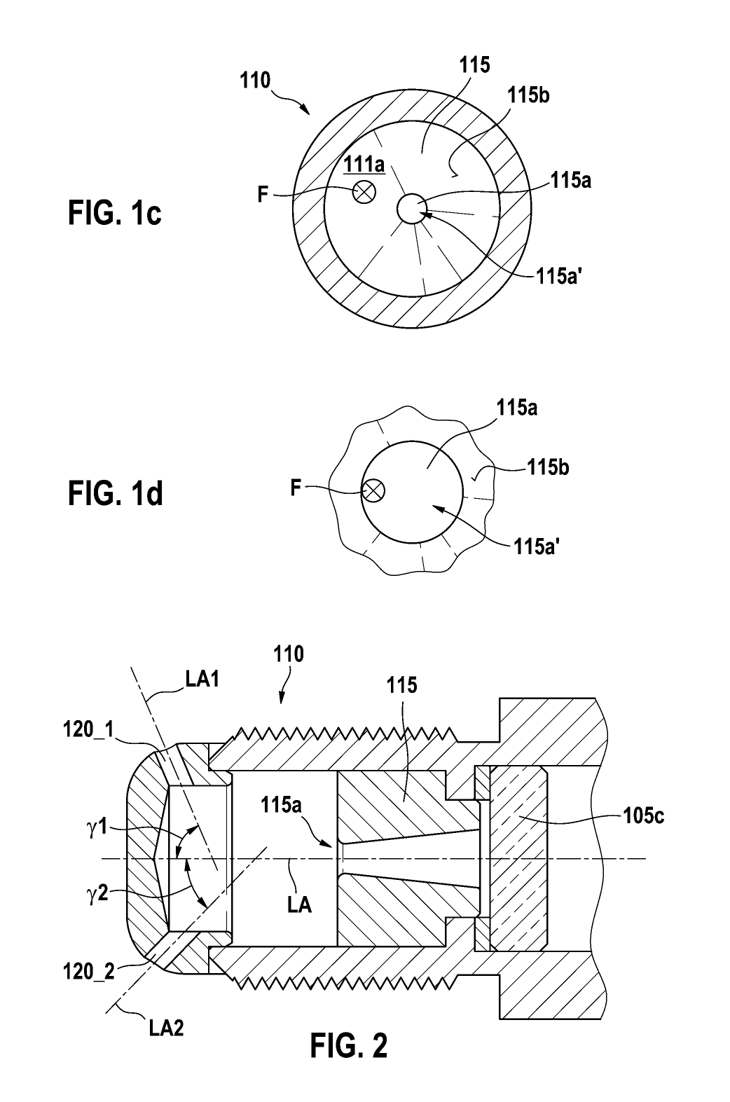

FIG. 1a shows a partial cross-section of a first specific embodiment of laser spark plug 100 according to the present invention. Laser spark plug 100 has a laser radiating arrangement 105 for radiating laser radiation 20 onto at least one ignition point ZP that is situated in a prechamber 110 allocated to laser spark plug 100.

The laser radiating arrangement 105 including, for example, a solid-state laser 105a that can have passive Q-switching (not shown) and that, when supplied with pumped light, produces energy-rich laser ignition impulses 20 in a known manner. A focusing optics 105b is allocated to solid-state laser 105a, and bundles laser radiation 20 produced by solid-state laser 105a onto ignition point ZP. In its end region facing prechamber 110, laser spark plug 100 includes a combustion chamber window 105c through which laser radiation 20 is radiated into prechamber 110 and that seals prechamber 110 from a remainder of the internal space of laser spark plug 100.

Laser spark plug 100 can for example be operated in a stationary gas engine or also in an internal combustion engine of a motor vehicle, and is used to ignite an air/fuel mixture situated in combustion chamber 200. A fluid exchange between the main combustion chamber, also designated external space 200, of the internal combustion engine or of the gas engine, and internal space 111 of prechamber 110 is enabled by one or more crossflow channels 120 in the region of the prechamber wall.

In addition, laser spark plug 100 includes a screen 115 that, as seen in FIG. 1a, is situated between laser source 105 of laser spark plug 100 and prechamber 110 in such a way that the produced laser radiation 20 can be radiated through a corresponding through-opening of the screen 115 into internal space 111 of prechamber 110, in particular onto ignition point ZP. Accordingly, the screen 115 advantageously enables the radiation of laser radiation 20 onto ignition point ZP, while at the same time an accumulation of dirt particles and other combustion products (oil ashes and the like), on a surface of combustion chamber window 105c that faces prechamber 110, is reduced due to the through-opening of the screen 115, which has a relatively small opening cross-section.

Instead of the local production of laser radiation 20 in laser spark plug 100, laser spark plug 100 can also be supplied with laser radiation for a laser ignition that is produced by a laser source (not shown) situated externally to laser spark plug 100.

According to an example embodiment of the present invention, the at least one crossflow channel 120 is situated and fashioned in such a way that, when a fluid (e.g., an ignitable mixture) flows out of external space 200 (main combustion chamber of the gas engine) through crossflow channel 120 into internal space 111 of prechamber 110, there results a fluid flow whose direction of flow is at an angle of a maximum of approximately 30° relative to a longitudinal axis of prechamber 110, and that is directed into a spatial region of prechamber 110 that lies essentially predominantly, preferably completely, outside a central region of the outlet opening of the screen 115.

In this way, it is advantageously ensured that, on the one hand, optimal ignition conditions are provided with regard to the fluid flow in prechamber 110, and that on the other hand a direct application of a corresponding fluid flow from internal space 111 of prechamber 110 onto combustion chamber window 105c is avoided to the greatest possible extent, in order to reduce the deposition of dirt particles and combustion products onto window 105c.

FIG. 1b shows a detail view of prechamber 110 according to FIG. 1a, in a partial cross-section. Block arrow F here symbolizes the fluid flow F that arises in prechamber 110, or in its internal space 111, as a result of the configuration according to the present invention of crossflow channels 120, this fluid flow being made up in a known manner of an ignitable air/fuel mixture and/or at least partly of exhaust gas. Advantageously, a direction of flow of fluid flow F is such that an angle α between the direction of flow and the longitudinal axis LA, corresponding essentially to the optical axis of laser spark plug 100, of prechamber 110 (or the parallel to longitudinal axis LA, indicated in FIG. 1b by a broken line) does not exceed a preferred maximum value of approximately 30°. In this way, it is advantageously ensured that the formation of a dominant tumble flow in internal space 111 of prechamber 110 is avoided. At the same time, fluid flow F is advantageously directed in such a way that it is not oriented into the region of outlet opening 115a of screen 115, which opening 115a faces prechamber 110 and is for laser radiation 20; but rather, fluid flow F is oriented into a region 111a, situated radially further out, of internal space 111 of prechamber 110. In this way, the occurrence of a stagnation point flow in the region of combustion chamber window 105c is advantageously avoided, which stagnation point flow would otherwise result in a laser spark plug that includes a prechamber if fluid flow F were able to flow directly through outlet opening 115a of screen 115 onto combustion chamber window 105c.

According to investigations carried out by the inventors, the loading of combustion chamber window 105c with undesired particles can already be significantly reduced if, through a corresponding configuration of crossflow channels 120, it is ensured that fluid flow F resulting in prechamber 110 at least does not meet outlet opening 115a centrally, i.e., along longitudinal axis LA of prechamber 110.

FIG. 1c schematically shows a top view of prechamber 110 according to FIG. 1b, in a partial cross-section. In FIG. 1c, an end face 115b of screen 115, which end face 115b faces internal space 111 of prechamber 110, is visible. The direction of view of FIG. 1c /./.runs along longitudinal axis LA (FIG. 1b) in the direction of combustion chamber window 105c.

From FIG. 1c it can be seen that fluid flow F is advantageously not directed onto a central region 115a′ of outlet opening 115a of screen 115, but rather is directed onto a region 111a that is situated radially further outward, in which it would be expected that a stagnation point flow would arise as a result of loading with fluid flow F. However, such a stagnation point flow in region 111a clearly cannot result in a significant contamination of combustion chamber window 105c, because the penetration of corresponding particles into the intermediate space between combustion chamber window 105c and screen 115 (FIG. 1b) is prevented by end face 115b of screen 115. This means that, in the case of the configuration according to FIG. 1c, at most, small portions of a fluid flow can propagate through outlet opening 115a in the direction toward combustion chamber window 105c.

FIG. 1d schematically shows a top view of outlet opening 115a of screen 115 according to a further specific example embodiment. In this specific embodiment, crossflow channels 120 (FIG. 1b) of the laser spark plug containing screen 115 are configured in such a way that fluid flow F is directed onto a radially outer edge region of outlet opening 115a. According to investigations carried out by the inventors, such an orientation of fluid flow F significantly reduces the loading of combustion chamber window 105c (FIG. 1b) with dirt particles.

That is, the fact that fluid flow F according to FIG. 1d is not directed into a radially inner, central region 115a′ of outlet opening 115a, but rather is directed into the radially outer region, contributes to a lower contamination of combustion chamber window 105c, and thus to an increase in the useful life of laser spark plug 100.

FIG. 2 shows a prechamber 110 according to a further specific example embodiment of the present invention. In the prechamber configuration shown in FIG. 2, two example crossflow channels 120_1, 120_2, fashioned for example as essentially circular-cylindrical crossflow bores, are shown. Crossflow channels 120_1, 120_2 can instead be of other geometries rather than the mentioned circular-cylindrical geometries. According to an example embodiment of the present invention, longitudinal axis LA1 of first crossflow channel 120_1 forms a first angle γ1 to longitudinal axis LA of prechamber 110, while longitudinal axis LA2 of second crossflow channel 120_2 forms a second angle γ2, differing from first angle γ1, to longitudinal axis LA of prechamber 110 (i.e., γ1≠γ2), thereby forming different points of intersection of longitudinal axes LA1 LA2 with longitudinal axis LA of prechamber 110 in different axial regions of prechamber 110. According to investigations carried out by the inventors, the configuration shown in FIG. 2 of crossflow channels 120_1, 120_2 also advantageously contributes to the promotion of a fluid flow (not shown). In particular, through the asymmetrical configuration with regard to longitudinal axes LA1 LA2 and their angles γ1, γ2, a stagnation point flow does not form directly in the region of outlet opening 115a with a resulting direction of flow onto combustion chamber window 105c.

Rather, in the configuration shown in FIG. 2, a stagnation point flow will arise, at most, in a radially outer region; but in no case will it arise in a central region of outlet opening 115a.

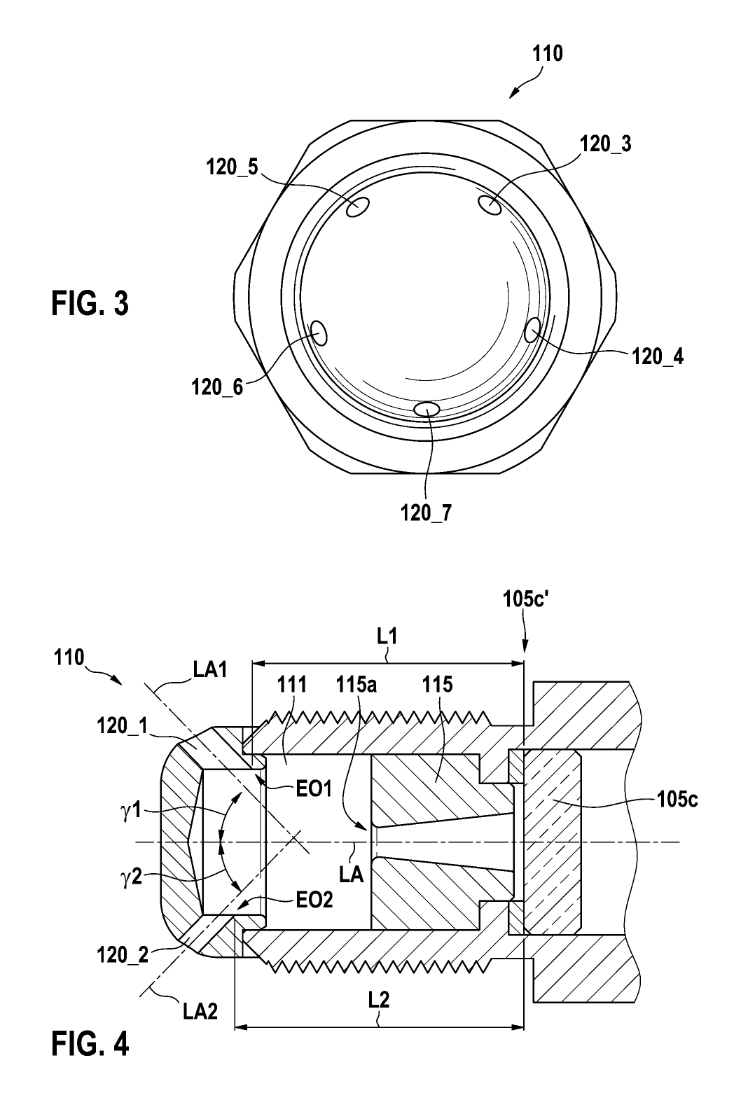

FIG. 3 shows a top view of an end region of a prechamber 110, which end region faces the combustion chamber, according to a further specific example embodiment of the present invention. Overall, the depicted prechamber 110 has five crossflow channels 120_3, 120_4, 120_5, 120_6, 120_7. In the present case, crossflow channels 120_3, 120_4 are fashioned in such a way that they form a first angle γ1 (FIG. 2) with longitudinal axis LA of prechamber 110. In contrast, the three further crossflow channels 120_5, 120_6, 120_7 are fashioned in such a way that they each form a second angle γ2 (FIG. 2) with longitudinal axis LA of prechamber 110, where γ1≠γ2. Overall, there again results from this an essentially asymmetrical configuration of crossflow channels 120_3, . . . , 120_7, promoting the formation of a described fluid flow F (FIG. 1b).

FIG. 4 shows a prechamber 110 according to a further example embodiment of the present invention. Differing from the configuration according to FIG. 2, both crossflow channels 120_1, 120_2 form the same angle γ1=γ2 relative to longitudinal axis LA of prechamber 110. However, in the present case, first crossflow channel 120_1 is situated in the region of the wall of prechamber 110 in such a way that a point of entry EO1 at which it enters into internal space 111 of prechamber 110 is situated at a first distance L1 relative to a reference coordinate 105c′, measured along longitudinal axis LA of prechamber 110 or of laser spark plug 100. In the present case, reference coordinate 105c′ is formed by a surface of combustion chamber window 105c facing prechamber 110 or screen 115. Alternatively, however, the reference coordinate can also be formed by other surfaces or virtual surfaces that preferably extend essentially approximately orthogonal to longitudinal axis LA of prechamber 110 or to the optical axis of laser spark plug 100.

As can be seen in FIG. 4, second crossflow channel 120_2 is situated with a second distance L2 between its point of entry EO2 and reference coordinate 105c′, where L2>L1. In other words, point of entry EO2 of second crossflow channel 120_2 in FIG. 4 is situated somewhat farther to the left, i.e., closer to combustion chamber 200, than is point of entry EO1 of first crossflow channel 120_1.

Through the configuration of crossflow channels 120_1, 120_2 described above with reference to FIG. 4, the formation of fluid flow F (FIG. 1b) according to the present invention in internal space 111 of prechamber 110 is again promoted in such a way that in particular no stagnation point flow results in a radially inner region, i.e., along longitudinal axis LA, or in the region of outlet opening 115a of screen 115.

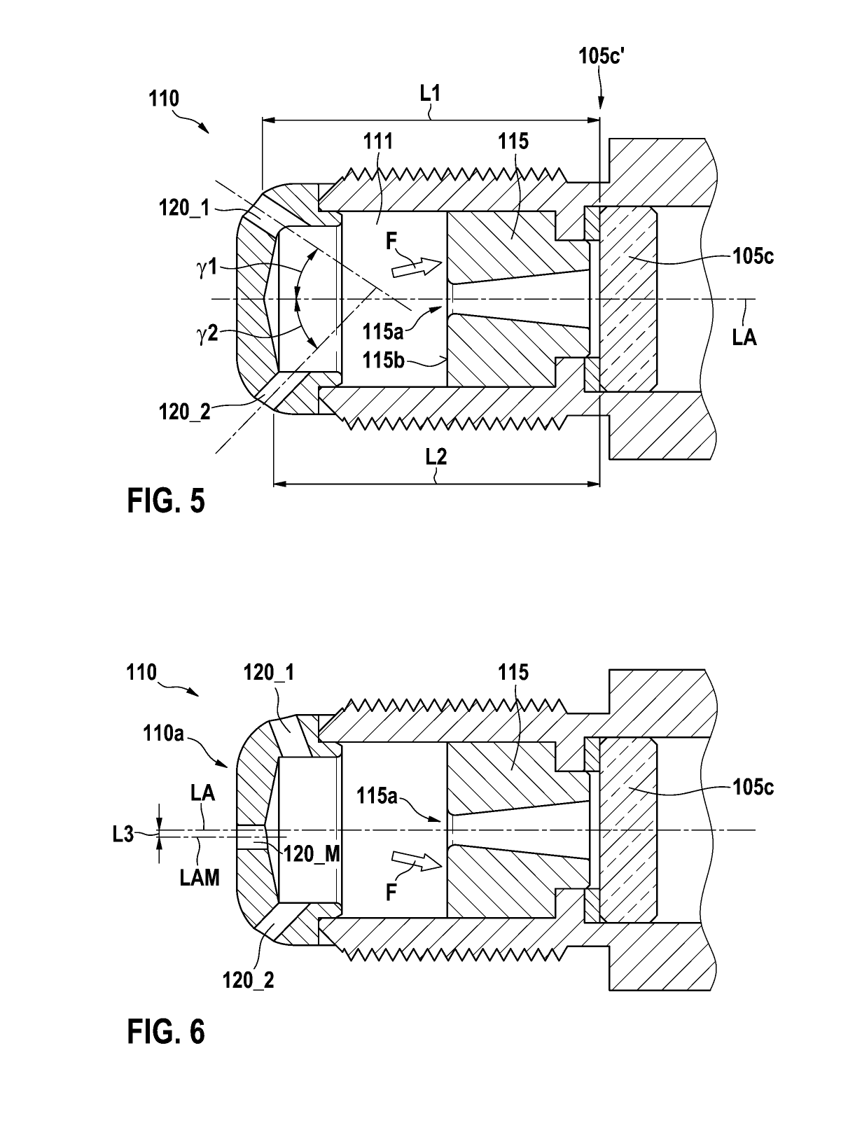

FIG. 5 schematically shows a detailed view of a further prechamber 110 according to an example embodiment of the present invention in a partial cross-section. In the embodiment shown in FIG. 5, again two crossflow channels 120_1, 120_2 are present that are fashioned differently both with regard to their angles γ1, γ2 relative to longitudinal axis LA and with regard to their spacings L1, L2 from reference coordinate 105c′. Correspondingly, there again results a fluid flow F that has a direction of flow at an angle of a maximum of approximately 30° relative to the longitudinal axis LA, and that is, in particular, not directed onto a central region of outlet opening 115a, but rather, as seen in FIG. 5, is directed onto a radially further outward-situated region of end face 115b of screen 115, which delimits internal space 111 of prechamber 110 at the right in FIG. 5.

FIG. 6 shows schematically, in a partial cross-section, a further prechamber 110 according to an example embodiment of the present invention. Prechamber 110 includes two radial crossflow channels 120_1, 120_2 that can be configured in a manner corresponding to the above-described exemplary embodiments. Alternatively, the two crossflow channels 120_1, 120_2 can, however, also be realized radially and symmetrically, i.e., can, in particular, form the same angle between their respective longitudinal axes and longitudinal axis LA of prechamber 110, as well as be at an identical distance from a reference point along longitudinal axis LA of prechamber 110 or laser spark plug 100.

In FIG. 6, in addition to radial crossflow channels 120_1, 120_2, prechamber 110 includes a further crossflow channel, shown in FIG. 6 to be fashioned as center hole 120_M, that is situated in wall region 110a of prechamber 110 facing the combustion chamber, i.e., at the left in FIG. 6. According to this example embodiment of the present invention, center hole 120_M is axially offset relative to longitudinal axis LA of prechamber 110, i.e., longitudinal axis LAM of center hole 120_M is radially offset by a distance L3 relative to longitudinal axis LA of prechamber 110, so that again an asymmetrical fluid flow F from the external space into internal space 111 of prechamber 110 results.

As described above, the variant of the present invention according to FIG. 6, with axially offset center hole 120_M, can be used together with radial symmetrical crossflow channels 120_1, 120_2. However, in particular a combination of center hole 120_M with the asymmetrical crossflow channels according to FIGS. 2, 4 is also possible.

A tilting of longitudinal axis LAM of center hole 120_M relative to longitudinal axis LA of prechamber 110 is also conceivable, e.g., at an angle up to approximately 30°, preferably between approximately 10° and approximately 30°.

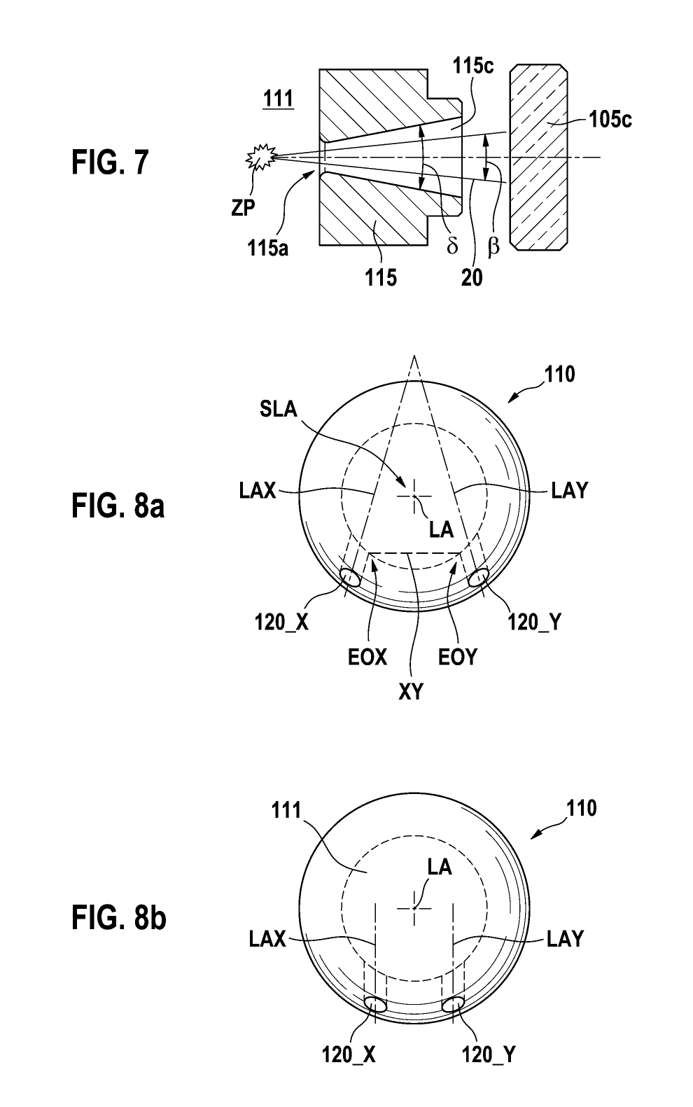

FIG. 7 schematically shows a partial cross-section of screen 115, as contained in the beam path of laser spark plug 100 according to FIG. 1a. As can be seen in FIG. 7, screen 115 includes an essentially cone-shaped through-opening 115c for the radiation of laser radiation 20 from combustion chamber window 105c onto ignition point ZP in internal space 111 of prechamber 110. According to a variant of the present invention, a corresponding opening angle δ of through-opening 115c is preferably selected such that it is approximately equal to or larger than radiation angle β of laser radiation 20.

In this way, there results on the one hand a particularly efficient, undisturbed radiation of laser radiation 20 onto ignition point ZP in internal space 111 of the prechamber, while at the same time the entry of disturbing particles from internal space 111 of prechamber 110 in the direction of combustion chamber window 105c is minimized

FIG. 8a schematically shows a top view of a prechamber 110 according to a further specific example embodiment of the present invention. In the present case, two crossflow channels 120_X, 120_Y are situated in such a way that their longitudinal axes LAX and LAY each do not intersect longitudinal axis LA of prechamber 110. This means that crossflow channels 120_X, 120_Y are not “radial crossflow channels” in the sense of the above description. In addition, longitudinal axes LAX, LAY of crossflow channels 120_X, 120_Y form, together with an imaginary connecting line XY between respective entry points EOX, EOY of crossflow channels 120_X, 120_Y into prechamber 110, an imaginary triangle such that longitudinal axis LA of prechamber 110 intersects the imaginary triangle at intersection point SLA. In this way, it is advantageously ensured that, due to the situation of crossflow channels 120_X, 120_Y, partial flows that result when fluid flows into prechamber 110 essentially mutually compensate one another with tangential components, so that in particular no dominant swirl flow can propagate in prechamber 110. At the same time, in addition, crossflow channels 120_X, 120_Y are fashioned and situated such that the further discussed criteria according to the present invention (angle α between the direction of flow of the resulting fluid flow F (FIG. 1b), and avoidance of the stagnation point flow in the region of longitudinal axis LA of prechamber 110) are present.

In a further specific example embodiment, the situation of crossflow channels 120_X, 120_Y can take place in such a way that at least one angle bisector of the imaginary triangle of the above-described specific embodiment intersects the longitudinal axis LA, or optical axis, of prechamber 110. For example, this can be the case for the angle bisector of the angle formed by sides LAX, LAY of the imaginary triangle.

FIG. 8b shows a further specific example embodiment of the present invention in which two crossflow channels 120_X, 120_Y are situated essentially parallel to one another, so that longitudinal axis LA of prechamber 110 is situated between longitudinal axes LAX, LAY. In this configuration of crossflow channels 120_X, 120_Y as well, the formation of a dominant swirl flow in prechamber 110 is effectively avoided.

The example configurations according to the present invention advantageously enable the formation of a fluid flow F (FIG. 1b) in internal space 111 of prechamber 110 in such a way that when the fluid flows into prechamber 110 no main turbulence, i.e., no swirl flow, forms about longitudinal axis LA of prechamber 110, or of laser spark plug 100.

Screen 115, also designated the “light path,” is preferably fashioned as a cylindrical base body including a hollow cone that tapers going out from combustion chamber window 105c in the direction of prechamber 110 (FIG. 1a) and whose cone geometry, in particular cone angle δ (FIG. 7) is selected such that the jacket surface of the hollow cone runs very close to laser beam 20, but does not impair it in the sense of an optical screen. Particularly preferably, opening angle δ of the hollow cone approximately coincides with radiation angle β of laser beam 20. Alternatively, however, it can also be provided that opening angle δ of the hollow cone differs by up to approximately 20° from radiation angle δ of laser radiation 20. This means that the difference δ−β between opening angle δ of the hollow cone and radiation angle β of laser beam 20 moves in a range of values of from approximately 0° to approximately 20°.

In a particularly preferred example embodiment, an axial length of screen 115 (measured along longitudinal axis LA of prechamber 110) is in the range of from approximately 2 mm to approximately 10 mm, in particular approximately 6 mm.

The design according to the present invention advantageously enables the formation of a dominant fluid flow F in internal space 111 of prechamber 110 that is axially offset; that is, there is no direct inflow, in particular no stagnation point flow, into hollow cone 115c (FIG. 7) of screen 115, resulting in a greatly reduced stagnation point flow onto combustion chamber window 105c (FIG. 1a).

In a further advantageous example embodiment, crossflow channels 120 can also be situated to form one or more points of intersection of their longitudinal axes with longitudinal axis LA of prechamber 110.

In a further advantageous example embodiment, it is provided that a plurality of crossflow channels are situated in such a way that an intersection point of their longitudinal axes has a radial distance from longitudinal axis LA of prechamber 110 that is a maximum of approximately ⅔ of a minimum diameter of through-opening 115c (FIG. 7), preferably approximately 50% of the minimum diameter of through-opening 115c. Distances of approximately ⅓ of the minimum diameter of through-opening 115c are also conceivable.

If the longitudinal axes of the crossflow channels do not intersect in a point, then instead of the above-named intersection point a point can also be selected for the dimensioning of the above-named maximum distance at which the sum of the distances (in the geometrical sense, i.e., the shortest distance) between this point and the plurality of longitudinal axes is approximately minimized

In a further advantageous example embodiment, center hole 120_M (FIG. 6) can be situated and oriented in such a way that its longitudinal axis LAM forms an angle of approximately 10° to approximately 30° with longitudinal axis LA of prechamber 110.

Different diameters, or diameter courses, for the crossflow channels over their length are also conceivable.

In addition, it is possible to realize one or more of crossflow channels 120 as conical bores, whose minimum cross-sectional surfaces are approximately in the center of the prechamber wall.

A combination of the above-described example embodiments of the present invention are can also be provided.

In addition, according to an example embodiment, the geometry of prechamber 110 is asymmetrical, and/or further arrangements, such as flow flaps or the like, are provided which influence a fluid flow F in prechamber 110.

According to an example embodiment, the screen 115 is provided with an axially offset light path or with a plurality of light paths, i.e., through-openings 115c (FIG. 7).

The designs, according to the described example embodiments of the present invention, of the situation and realization of crossflow channels 120 in order to form the specific fluid flow F (FIG. 1b) is also applicable to high-voltage spark plugs.

1-10. (canceled)

11. A laser spark plug comprising:
a prechamber configured to accommodate an ignitable medium;
an arrangement for radiating laser radiation onto at least one ignition point, which at least one ignition point is in the prechamber;
at least one crossflow channel that enables a fluid connection between an internal space of the prechamber and a space that is external to the prechamber; and
a screen arranged between the radiating arrangement and the internal space of the prechamber;
wherein:
the screen includes at least one outlet opening to the internal space of the prechamber for entry of the laser radiation into the internal space of the prechamber;
the at least one crossflow channel at least one of positioned and structured to cause a fluid to flow through the at least one crossflow channel and into a spatial region of the internal space of the prechamber at a direction that forms a non-zero angle of a maximum of approximately 30° relative to a longitudinal axis of the prechamber; and
the spatial region is situated at least predominantly outside a central region of the outlet opening of the screen.

12. The laser spark plug of claim 11, wherein the at least one crossflow channel includes at least two crossflow channels situated such that:
a longitudinal axis of a first of the at least two crossflow channels forms a first angle (γ₁) to the longitudinal axis of the prechamber;
a longitudinal axis of the second overflow channel forms a second angle (γ₂) to the longitudinal axis of the prechamber; and
the second angle (γ₂) is different from the first angle (γ₁).

13. The laser spark plug of claim 12, wherein the at least two crossflow channels are situated such that:
a point of entry of the first crossflow channel into the prechamber is at a first distance from an axial reference point;
a point of entry of the second crossflow channel into the prechamber is at a second distance from the axial reference point; and
the first and second distances are different.

14. The laser spark plug of claim 13, wherein:
the at least one crossflow channel further includes a center hole situated in a wall of the prechamber at a combustion chamber side of the prechamber;
the center hole overlaps the longitudinal axis of the prechamber; and
a longitudinal axis of the center hole is offset from the longitudinal axis of the prechamber.

15. The laser spark plug of claim 12, wherein:
the at least one crossflow channel further includes a center hole situated in a wall of the prechamber at a combustion chamber side of the prechamber;
the center hole overlaps the longitudinal axis of the prechamber; and
a longitudinal axis of the center hole is offset from the longitudinal axis of the prechamber.

16. The laser spark plug of claim 11, wherein the at least one crossflow channel includes at least two crossflow channels situated such that:
a point of entry of the first crossflow channel into the prechamber is at a first distance from an axial reference point;
a point of entry of the second crossflow channel into the prechamber is at a second distance from the axial reference point; and
the first and second distances are different.

17. The laser spark plug of claim 16, wherein:
the at least one crossflow channel further includes a center hole situated in a wall of the prechamber at a combustion chamber side of the prechamber;
the center hole overlaps the longitudinal axis of the prechamber; and
a longitudinal axis of the center hole is offset from the longitudinal axis of the prechamber.

18. The laser spark plug of claim 11, wherein:
the at least one crossflow channel includes a center hole situated in a wall of the prechamber at a combustion chamber side of the prechamber;
the center hole overlaps the longitudinal axis of the prechamber; and
a longitudinal axis of the center hole is offset from the longitudinal axis of the prechamber.

19. The laser spark plug of claim 18, wherein the longitudinal axis of the center hole is parallel to the longitudinal axis of the prechamber.

20. The laser spark plug of claim 11, wherein the at least one crossflow channel includes at least two crossflow channels whose longitudinal axes each intersects the longitudinal axis of the prechamber.

21. The laser spark plug of claim 11, wherein:
the at least one crossflow channel includes two crossflow channels whose longitudinal axes each does not intersect the longitudinal axis of the prechamber; an
(a) the longitudinal axes of the two crossflow channels and (b) a line drawn between a point of entry of a first one of the two crossflow channels into the prechamber and a point of entry of a second one of the two crossflow channels into the prechamber form three sides of a triangle that includes a point at which the longitudinal axis of the prechamber intersects the triangle.

22. The laser spark plug of claim 11, wherein the at least one crossflow channel includes two crossflow channels that are approximately parallel to each other and that are arranged such that the longitudinal axis of the prechamber lies between the respective longitudinal axes of the two crossflow channels.

23. The laser spark plug of claim 11, wherein
the at least one crossflow channel includes a plurality of crossflow channels; and
an angular spacing, circumferentially about the prechamber, between a first pair of adjacent ones of the plurality of crossflow channels is different than an angular spacing, circumferentially about the prechamber, between a second pair of adjacent ones of the plurality of crossflow channels.

24. The laser spark plug of claim 11, wherein, with respect to each of at least one of the at least one crossflow channel, a first cross-section of the respective crossflow channel differs, with respect to at least one of form and surface area, from a second cross-section of the respective crossflow channel.

25. The laser spark plug of claim 11, wherein at least one through-channel of the screen is approximately frustum-shaped, and an opening angle of the through-channel is one of larger than and approximately equal to an angle of radiation of the laser radiation.

26. The laser spark plug of claim 11, wherein the spatial region is situated completely outside the central region of the outlet opening of the screen.

27. The laser spark plug of claim 11, wherein the laser spark plug is arranged for causing combustion in an internal combustion engine of a motor vehicle.

28. The laser spark plug of claim 11, wherein the laser spark plug is arranged for causing combustion in a gas engine.
